(19) United States
(12) Patent Application Publication
(10) Pub. No.: US 2006/0118325 A1
(43) Pub. Date: Jun. 8, 2006

(54) Electric wire and wire harness

(76) Inventors: Kiyoshi Yagi, Shizuoka (JP); Takeshi Kamata, Shizuoka (JP); Shigeharu Suzuki, Shizuoka (JP); Keigo Sugimura, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/523,979

(22) PCT Filed: Aug. 6, 2003
(86) PCT No.: PCT/JP03/09994

§ 371 Date: Oct. 18, 2005

(30) Foreign Application Priority Data
Aug. 9, 2002 (JP) 2002-233727

(51) Int. Cl. H01B 7/00

(52) U.S. Cl. 174/135

(57) ABSTRACT

A wire harness 3 includes a first electric wire 1, a second electric wire 2, connectors 8 and a tube for a harness. First markings 6 and second markings 7 are formed on the outer surface 5a of the first and second electric wires 1 and 2. The first markings 6 and second markings 7 are arranged in the longitudinal direction of the first and second electric wires 1 and 2. The connector 8 is attached to the end of each of the first and second electric wires 1 and 2. The second electric wire 2 is accommodated in the tube 9 for a harness in the middle. The first marking 6 on the second electric wire 2 is shorter than the first marking 6 on the first electric wire 1. The second marking 7 on the second electric wire 2 is shorter than the second marking 7 on the first electric wire 1. The interval between the markings 6 and 7 on the second electric wire 2 is shorter than the interval between the markings 6 and 7 on the first electric wire 1. This configuration can provide a wire which can be easily identified and prevent a wire harness to be assembled from being reduced in quality, and such a wire harness which can prevent the reduction in quality of itself.

### TECHNICAL FIELD

This invention relates to an electric wire composed of a conductive core and an insulating coating for coating the core, and a wire harness including such an electric wire and others.

### BACKGROUND ART

A motor vehicle which is a moving body incorporates various electronic instruments. In the motor vehicle, therefore, a wire harness is arranged in order to supply the electric power from a power source and a control signal from a computer. The wire harness includes a plurality of electric wires 100, and a connector attached to the end of each electric wire.

The electric wire 100, as seen from FIG. 8, includes a conductive core 101 and a coating 102 of insulating synthetic resin which coats the core 101. The electric wire 100 is a “coated wire”. The electric wire 100 is made by extrusion-coating the outer wall of the core 101 with the insulating synthetic resin. During the extrusion coating, a desired coloring agent is mixed in the above synthetic resin so that the electric wire is colored in a desired color.

The connector includes a conductive terminal fitting and and an insulating connector housing. The terminal fitting is attached to the end of the electric wire 100 and connected to the core 101 of the electric wire 100. The connector housing is formed in a box shape and incorporates the terminal fitting.

In assembling the wire harness, first, the electric wire 100 is cut in prescribed lengths. The terminal fitting is attached to each electric wire 100. As necessary, the electric wires 100 after cut are connected to one another. Thereafter, the terminal fitting is inserted into the connector housing. Thus, the wire harness is assembled.

The electric wires 100 of the wire harness must be distinguished in terms of the size of the core 101, material of the coating 102 (presence or absence of heat resistance) and a using purpose. Incidentally, the using purpose designates the system of the motor vehicle in which the control signal (e.g. vehicle speed information) for an air bag, ABS (Antilock Brake System) or driving force is transmitted.

In order to identify the above using object (system), in the electric wire 100 shown in FIG. 8, the outer surface 102a of the coating 102 is formed in stripes with two different colors A and B (diagonally shaded in parallel). The electric wire 100 shown in FIG. 8 is made in such a manner that during the above extrusion-coating, the coloring agent with color A is mixed into the synthetic resin, and after extrusion-coating, a part of the outer surface 102a is colored in color B. In the electric wire 100 shown in FIG. 8, the portion with color A and portion with color B are arranged in parallel in the longitudinal direction of the electric wire 100, and circumferential direction of the electric wire 100.

On the other hand, various demands are offered from users. Therefore, the motor vehicle is demanded to load more various electronic instruments. As the case may be, the wire harness adopts about one hundred kinds of electric wires 100. In this case, the electric wires 100 with various colors are used. Thus, in the electric wire 100 shown in FIG. 8, the color A of the coloring agent to be mixed into the synthetic resin constituting the coating 102 and the color B of the coloring agent for coloring after the coating step are combined in various manners.

The wire harness described above has a tendency of increasing the weight owing to the loading of various electronic instruments in the motor vehicle. In order to reduce the weight of the wire harness, therefore, it is eagerly demanded that the electric wire 100 is thinned. In the electric wire 100 with the stripes shown in FIG. 8, thinning of the electric wire 100 necessarily leads to thinning of the portion with color A and portion with color B. This makes it difficult to identify the combination of these colors A and B. This also increases the possibility of erroneous arrangement of the wire 100, thereby reducing the quality of the wire harness.

Therefore, an object of this invention is to provide an electric wire which can be easily identified and prevent a wire harness to be assembled from being reduced in quality, and such a wire harness which can prevent the reduction in quality of itself.

The invention described in claim 1 is an electric wire including a conductive core and a coating which is made of synthetic resin and coats the core, comprising:

a first marking formed by coloring a portion of an outer surface of the coating with a first color which is different from that of the outer surface; and

a second marking formed by coloring another portion of the outer surface of the coating with a second color which is different from both the of the outer surface and the first color, wherein

the first marking and the second marking are arranged in a longitudinal direction of the coating.

The invention described in claim 2 is an electric wire according to claim 1, wherein the first marking and the second marking are apart from each other.

The invention described in claim 3 is an electric wire according to claim 1 or 2, wherein the outer surface of the coating is white.

The invention described in claim 4 is a wire harness having a first electric wire connected to a connector at its end, and a second electric wire connected to another connector at its end and accommodated in an exterior component in the middle in the longitudinal direction thereof, wherein the first electric wire and the second electric wire each including a conductive core, a coating which is made of synthetic resin and coats the core, a first marking formed by coloring a portion of an outer surface of the coating with a first color which is different from that of the outer surface; and a second marking formed by coloring another portion of the outer surface of the coating with a second color which is different from both the of the outer surface and the first color, wherein

the first marking and the second marking are arranged in a longitudinal direction of the coating,

the length of each of the first marking and the second marking of the second electric wire in the longitudinal direction is shorter than that of each of those of the first electric wire in the longitudinal direction, and

the interval between the first marking and the second marking of the second electric wire is shorter than that of the first electric wire, and the first marking and second marking of the second electric wire are exposed from the exterior component at the end of the second electric wire.

In accordance with the invention described in claim 1, the first and second markings are arranged in the longitudinal direction of the coating, i.e. the electric wire. For this reason, the width of the first marking and the second marking in the circumferential direction of the electric wire can be increased.

In this specification, coloring the outer surface of the coating is to color the outer surface of the coating of the electric wire with a coloring agent. The coloring agent is a liquid material with a coloring material (industrial organic material) being solved and dispersed in water or other solvents. The organic material includes a dye or pigment (most thereof is the organic material and synthetic material). As the case may be, the dye is employed as the pigment whereas the pigment is employed as the dye. As a more concrete example, the coloring agent is a coloring liquid or paint. The coloring liquid is a solvent in which dye is solved or dispersed. The paint is a liquid in which pigment is dispersed. Therefore, when the coloring agent is applied to the outer surface of the electric wire, the dye soaks into the coating, and when the paint is applied to the outer surface of the electric wire, the pigment adheres to the outer surface without soaking into the coating. In short, coloring the outer surface of the electric wire is to dye portions of the electric wires with the dye, or to paint portions of the electric wire with the pigment.

The above solvent and dispersion liquid are desired to have affinity for the synthetic resin constituting the coating. In this case, the dye surely soaks into the coating or the pigment surely adheres to the outer surface of the coating.

In accordance with the invention described in claim 2, said first marking and said second marking are apart from each other. For this reason, the first marking and the second marking are easily distinguished from each other, and both of them can be easily distinguished from the outer surface of the coating.

In accordance with the invention described in claim 3, the outer surface of said coating is white. For this reason, both of the first marking and the second marking can be easily distinguished from the outer surface of the coating.

In accordance with the invention described in claim 4, in each of the first and second electric wire which constitute the wire harness, the first marking and the second marking are formed on the outer surface of the coating. The first marking and said second marking are arranged in a longitudinal direction of said coating, i.e. electric wire. For this reason, the width of each of the first marking and the second marking can be increased. Therefore, the first marking and the second marking can be easily distinguished from each other, and both of them can be distinguished from the outer surface of the coating.

The length of each of said first marking and said second marking and the interval therebetween of said second electric wire accommodated in the exterior component is shorter than that of each of these markings and the interval therebetween of said first electric wire in the longitudinal direction. The length of each of the first marking and the second marking and the interval therebetween of the second electric wire are those when these markings are exposed from the exterior component at the end of the second electric wire. For this reason, the first electric wire and the second electric wire accommodated in the exterior component can be easily visually recognized. Therefore, the first marking and second marking can be easily distinguished from each other.

The exterior components described in the specification are various components which are attached to the electric wires constituting the wire harness and cover (or accommodate) a part of the electric wires. It is of course that the exterior components constitute the wire harness. The exterior components are e.g. a tube for a harness, protector for a harness, grommet for a harness, a clip for wiring, etc.

### BRIEF DESCRIPTION OF DRAWINGS

FIG. 1A is a perspective view showing a first electric wire according to an embodiment of this invention;

FIG. 1B is a side view of the first electric wire shown in FIG. 1A;

FIG. 2A is a perspective view showing a second electric wire according to the embodiment of this invention;

FIG. 2B is a side view of the second electric wire shown in FIG. 2A;

FIG. 3 is a perspective view showing the main part of the wire harness according to the first embodiment of this invention;

FIG. 4 is a perspective view showing the structure of a electric wire cutting apparatus equipped with a marking device for making the electric wire as shown in FIGS. 1 and 2;

FIG. 5 is a view for explaining the arrangement of the marking device shown in FIG. 4;

FIG. 6 is a view for mainly explaining the control device of the marking device shown in FIG. 5;

FIG. 7A is a perspective view showing a modification of the first electric wire;

FIG. 7B is a perspective view showing a modification of the second electric wire;

FIG. 8A is a perspective view of a conventional electric wire; and

FIG. 8B is a side view of the electric wire shown in FIG. 8A.

### BEST MODE FOR CARRYING OUT THE INVENTION

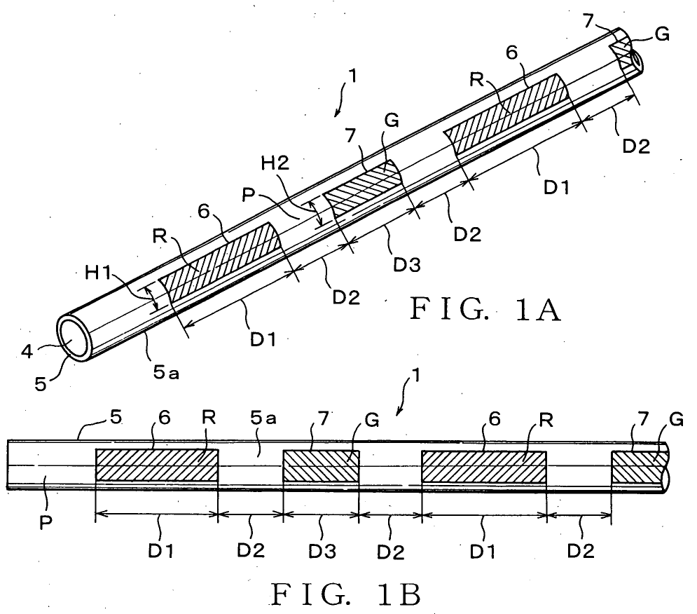

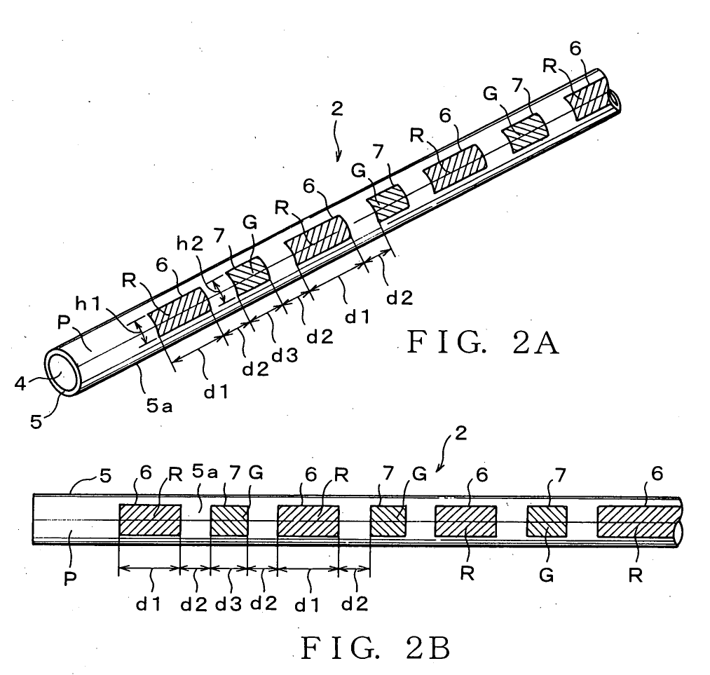

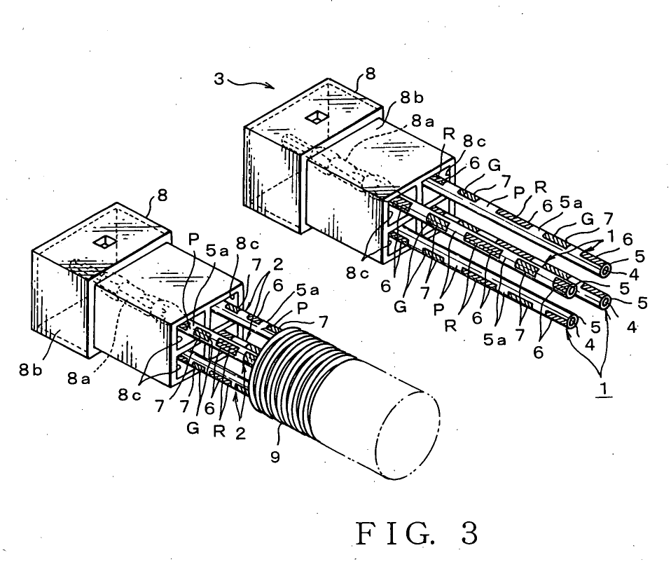

Now referring to FIGS. 1 to 6, an explanation will be given of the electric wire and wire harness according to an embodiment of this invention. A first electric wire 1 as shown in FIG. 1 and a second electric wire 2 as shown in FIG. 2 constitute a wire harness as shown in FIG. 3.

The first electric wire 1, as seen from FIGS. 1A and 1B, includes a conductive core 4 and an insulating coating 5. The core 4 is formed by twisting a plurality of conductive wires into a strand. The conductive wires which constitute the core 4 are made of conductive metal. The core 4 may be made of a single conductive wire. The coating 5 is made of synthetic resin such as PVC (polyvinylchloride). The coating 5 coats the core 4. Therefore, the outer surface of the coating 5 constitutes the outer surface of the first electric wire 1.

The coating 5 is colored in color P. The outer surface 5a may be colored in color P by mixing a desired coloring agent into the synthetic resin constituting the coating. The outer surface 5a may be colored in color P by the color of the synthetic resin itself without mixing the coloring agent into the synthetic resin constituting the coating 5. Where the color P is the color of the synthetic resin itself without mixing the coloring agent into the synthetic resin, the coating, i.e. the outer surface 5a of the first electric wire 1 is referred to as “non-colored”. In this way, “non-colored” means that the outer surface 5a of the first electric wire 1 is the color of the synthetic resin itself. Incidentally, the color P of the synthetic resin constituting the coating 5, i.e. the outer surface 5a is white.

At portions of the outer surface 5a of the first electric wire 1, first markings 6 and second markings 7 are made. The first markings 6 and second markings 7 are arranged in the longitudinal direction of the core 4 and coating 5, i.e. in the longitudinal direction of the first electric wire 1. The first markings 6 and the second markings 7 are alternately arranged in the longitudinal direction of the core 4 and coating 5, i.e. in the longitudinal direction of the first electric wire 1. The first markings 6 and the second markings 7 are arranged apart from each other in the longitudinal direction of the core 4 and coating 5, i.e. in the longitudinal direction of the first electric wire 1. The first markings 6 are colored in the first color R (shaped in parallel in FIG. 1) The first color R is different from color P. Therefore, the first markings 6 are formed in such a manner that portions of the outer surface 5a are colored in the first color R. The second markings 7 are colored in the second color G (shaped in parallel in FIG. 1). The second color G is different from both color P and the first color R. Therefore, the second markings 7 are formed in such a manner that portions of the outer surface 5a are colored in the second color G.

The length D1 of each of the first markings 6 in the longitudinal direction of the core 4 and coating 5, i.e. in the longitudinal direction of the first electric wire 1 is predetermined. The interval D2 between the first marking and second marking which are adjacent in the longitudinal direction of the core 4 and coating 5, i.e. in the longitudinal direction of the first electric wire 1 is predetermined. The length D3 of each of the second markings in the longitudinal direction of the core 4 and coating 5, i.e. in the longitudinal direction of the first electric wire 1 is predetermined.

The second electric wire 2 as shown in FIG. 2 is substantially the same as the first electric wire 1 in the configuration. Therefore, in the second electric wire 2, like reference numerals refer to like elements in the first electric wire 1. As shown in FIGS. 2A and 2B, like the first electric wire 1 as described above, the first markings 6 and second markings 7 are made. At portions of the outer surface 5a of the second electric wire 2, the first markings 6 are colored in the first color R. At portions of the outer surface 5a of the second electric wire 2, the second markings 7 are colored in the second color G.

The length d1 of each of the first markings 6 in the longitudinal direction of the core 4 and coating 5, i.e. in the longitudinal direction of the second electric wire 2 is predetermined. The interval d2 between the first marking 6 and second marking 7 which are adjacent in the longitudinal direction of the core 4 and coating 5, i.e. in the longitudinal direction of the second electric wire 2 is predetermined. The length d3 of each of the second markings 7 in the longitudinal direction of the core 4 and coating 5, i.e. in the longitudinal direction of the second electric wire 2 is predetermined.

The length d1 of the first marking 6 of the second electric wire 2 is shorter than the length D1 of the first marking 6 of the first electric wire 1. The interval d2 between the first marking 6 and the second marking 7 of the second electric wire 2 is narrower than the interval D2 between the first marking 6 and the second marking 7 of the first electric wire 1. The length d3 of the second marking 7 of the second electric wire 2 is shorter than the length of the second marking 7 of the first electric wire 1. Incidentally, in the illustrated example, the length d1 is half as long as the length D1, the interval d2 is half as long as the interval D2, and the length d3 is half as long as the length D3. The lengths d1 and d3 and the interval d2 are those enough to be exposed from the tube 9 for a harness at the end of the second electric wire 2.

The first electric wire 1 and second electric wire 2 constitute a wire harness 3 as shown in FIG. 3. The wire harness 3 includes a plurality of the first electric wires 1, a plurality of the second electric wires 2, a plurality of connectors 8 and the tube 9 for a harness which is an exterior component. In the illustrated example, the wire harness 3 includes four first electric wires 1, four second electric wires 2, and two connectors 8.

The first electric wires 1 are bundled and equipped with the one of the connectors 8 at their ends. The second electric wires 2 are bundled and equipped with the other of the connectors 8 at their ends. The central portion of the second electric wires 2 in the longitudinal direction is passed through the tube 9 for a harness (or accommodated).

The connector 8 includes conductive terminal fittings 8a and an insulating connector housing 8b. The terminal fittings 8a are made by bending a metal sheet. The terminal fittings 8a are attached to the ends of the first electric wires 1 or second electric wires 2. The terminal fittings 8a are electrically connected to the cores 4 of the first electric wire 1 and second electric wire 2.

The connector housing 8b is made of insulating synthetic resin and formed in a box shape. The connector housing 8b has terminal chambers 8c each accommodating the terminal fitting 8a. The connector housing 8b insulate the accommodated terminal fittings 8a from one another. The connector housing 8b is coupled with the connector housing of the connector of each of various electronic devices mounted in the motor vehicle. When the connector housing 8b is coupled with the connector housing of the connector of each of various electronic devices mounted in the motor vehicle, the terminal fitting 8a is connected electrically and mechanically to the terminal fitting of the connector of the electronic device. In this way, the connector 8 is coupled with the electronic device.

The tube 9 for a harness is made of rubber having elasticity and has flexibility. The tube 9 for a harness is cylindrical and corrugated. The center of a plurality of electric wires 2 is passed through the tube 9 for a harness. When the wire harness 3 is mounted in the motor vehicle, the tube 9 for a harness prevents the second electric wire 2 from being brought into contact with the panel of the motor vehicle and damaged.

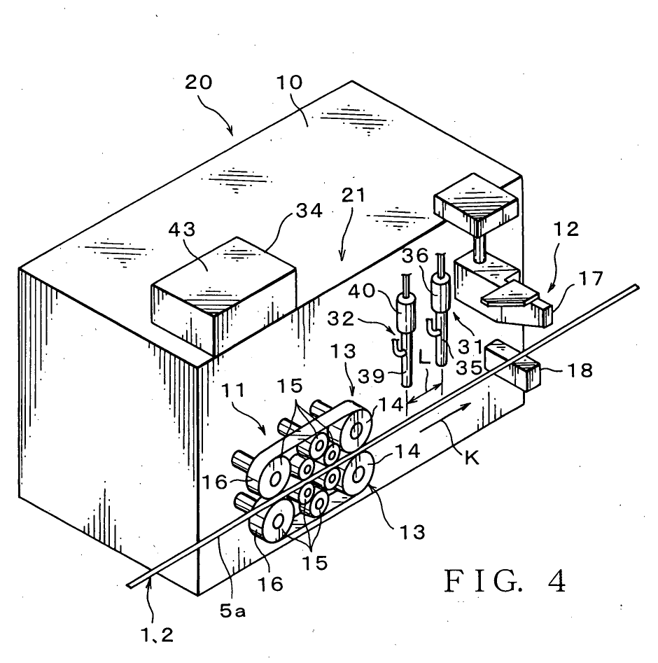

The first electric wire 1 and the second electric wire 2 which constitute the wire harness 3 having the configuration described above can be obtained in such a manner that the lengthy electric wires with no markings are cut in desired lengths by the electric wire cutting apparatus 20 as shown in FIG. 4 and are given the first markings 6 and second markings 7 by a marking device 21 as shown in FIG. 4. The coating 5 of each of the first and second electric wires 1 and 2 thus acquired is removed at the end. The terminal fitting 8a is attached to the core 4 exposed at the end. As necessary, the first electric wire 1 and 2 are connected to each other. After the second electric wire 2 has been passed through the tube 9 for a harness, the terminal fitting 8a is inserted in the terminal chamber 8c of the connector housing 8b. In this way, the wire harness 3 having the configuration described above is assembled.

The wire harness 3 thus assembled is arranged in the motor vehicle in such a manner that its connector 8 is coupled with the connector of the electronic device. The wire harness 3, i.e. electric wires 1 and 2 transfer electric power and control signal to the various electronic devices described above. In each electric wire, the colors R and G of the markings 6 and 7 may be the same. The colors R and G of the markings 6 and 7 of each electric wire can be employed to identify the kind of the electric wire, system, etc. In short, the colors R and G of the markings 6 and 7 are used to identify the using object of the wire harness 3.

The marking device 21, which serves to make the first and second markings 6 and 7 on the outer surface 5a of each of the first electric wire 1 and second electric wire 2, is attached to the electric wire cutting apparatus 20 as shown in FIG. 4.

The electric wire cutting apparatus 20, as shown in FIG. 4, includes a body 10 installed on a floor of a factory, a length measuring mechanism 11 and a cutting mechanism 12. The body 10 is formed in a box shape. The length measuring unit 11 includes a pair of belt shifting units 13.

The belt shifting unit 13 includes a driving pulley 14, a plurality of follower pulleys 15 and an “endless” belt 16. The driving pulley 14 is rotary-driven by a motor which is a driving source accommodated within the body 10. The follower pulleys 15 are rotatably supported within the body 10. The endless belt 16 is a ring-shaped belt which is hung over the driving pulley 14 and the follower pulleys 15. The endless belt 17 rotates around the pulleys 14 and 15.

The pair of belt shifting units 13 are arranged vertically. The pair of belt shifting units 13 shift out the first and second electric wires 1 and 2 by rotating synchronously the driving pulleys 14 with the first and second electric wires 1 and 2 sandwiched therebetween and rotating the endless belt 16. In this case, the pair of belt shifting units 13 shift the first and second electric wires 1 and 2 in the direction of arrow K in parallel to the longitudinal direction of the first and second electric wires 1 and 2. Incidentally, the arrow K is horizontally directed in this specification.

The cutting mechanism 12 is arranged downstream of the arrow K in the pair of belt shifting units 13. The cutting mechanism 12 is provided with a pair of cutting blades 17 and 18. The pair of cutting blades 17 and 18 are arranged vertically. The pair of cutting blades 17 and 18 operate to leave and approach each other vertically. When the pair of cutting blades 17 and 18 approach each other, they cut the first and second electric wires 1 and 2 shifted out from the pair of belt shifting units 13 while sandwiching them therebetween. When the pair of cutting blades 17 and 18 leaves each other, they necessarily leave the first and second electric wires 1 and 2.

In the state where the pair of cutting blades 17 and 18 of the cutting mechanism 12 have left each other, the electric wire cutting apparatus 20 shifts out the first and second electric wires 1 and 2 in the direction of arrow K while sandwiching the first and second electric wires 1 and 2 between the pair of belt shifting units 13. After the first and second electric wires 1 and 2 having a prescribed length have been shifted out, the pulleys 14 of the pair of belt shifting units 13 stop. Then, the pair of cutting blades 17 and 18 approach each other and cut the first and second electric wires 1 and 2 while sandwiching them therebetween. In this way, the electric wire cutting apparatus 20 shifts the first and second-electric wires 1 and 2 in the direction of arrow K.

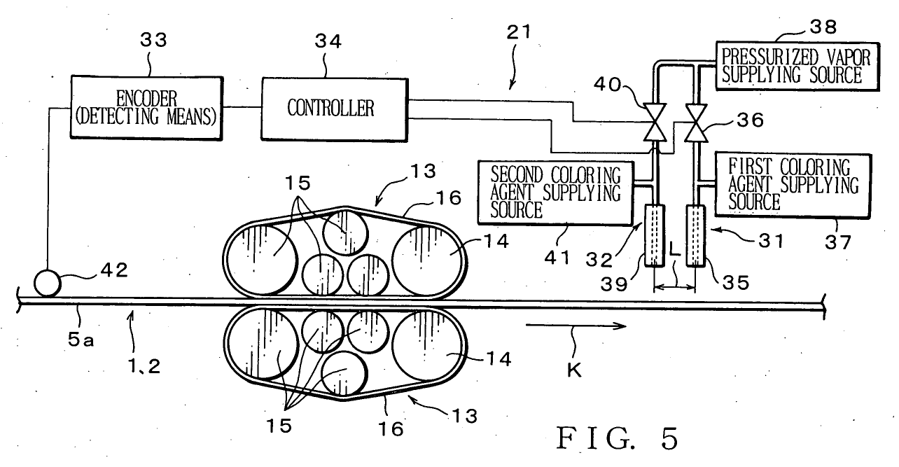

The marking device 21 serves to apply the first and second markings 6 and 7 on the outer surface 5a of each of the first and second electric wires 1 and 2. The marking device 21, as shown in FIG. 5, includes a first coloring unit 31 serving as a jetting means, a second coloring unit 32 serving as a jetting means, an encoder 33 serving as a detecting means and a control device 34. The first coloring unit 31 and the second coloring unit 32 are arranged in the direction of arrow K.

The first coloring unit 31, as seen from FIG. 4, is arranged between the pair of belt shifting units 13 of the length measuring mechanism 11 and the pair of cutting blades 17 and 18 of the cutting mechanism 12. The first coloring unit 31 includes a nozzle 35 and a valve 36. The nozzle 35 is opposite to the first and second electric wires 1 and 2 which are shifted in the direction of arrow K by the pair of belt shifting units 13. Into the nozzle 35, the first coloring agent is supplied from a first coloring agent source 37 (shown in FIG. 5). The first coloring agent has the first color R described above.

The valve 36 is coupled with the nozzle 35. With the valve 36, a pressurized vapor source 38 (shown in FIG. 5) is coupled. The pressurized vapor source 38 supplies the pressurized vapor to the nozzle 35 through the valve 36. Incidentally, the pressurized vapor source 38 also the pressurized vapor to a nozzle 39 through a valve (described later) of the second coloring unit 40. When the valve 36 is opened, the first coloring agent contained in the nozzle 35 is drop-jetted toward the outer surface 5a of each of the first and second electric wires 1 and 2 with the aid of the pressurized vapor supplied from the pressurized vapor source 38.

When the valve 36 is closed, the jetting of the first coloring agent from the nozzle 35 stops. In the first coloring unit 31 having the configuration described above, the valve 36 is opened for a prescribed time by a control signal from the control device 34 so that the a certain amount of the first coloring agent is drop-jetted toward the outer surface 5a of each of the first and second electric wires 1 and 2.

The second coloring unit 32, as seen from FIG. 4, is arranged between the pair of belt shifting units 13 of the length measuring mechanism 11 and the pair of cutting blades 17 and 18 of the cutting mechanism 12, and arranged nearer than the first coloring unit 31 to the pair of belt shifting unit 13. The second coloring unit 32 includes a nozzle 39 and a valve 40. The nozzle 39 is opposite to the first and second electric wires 1 and 2 which are shifted in the direction of arrow K by the pair of belt shifting units 13. Into the nozzle 39, the second coloring agent is supplied from a second coloring agent source 41 (shown in FIG. 5). The second coloring agent has the second color G described above.

The valve 40 is coupled with the nozzle 39. With the valve 40, a pressurized vapor source 38 (shown in FIG. 5) is coupled. When the valve 40 is opened, the second coloring agent contained in the nozzle 39 is drop-jetted toward the outer surface 5a of each of the first and second electric wires 1 and 2 with the aid of the pressurized vapor supplied from the pressurized vapor source 38. When the valve 40 is closed, the jetting of the first coloring agent from the nozzle 39 stops. In the second coloring unit 32 having the configuration described above, the valve 40 is opened for a prescribed time by a control signal from the control device 34 so that a certain amount of the second coloring agent is drop-jetted toward the outer surface 5a of each of the first and second electric wires 1 and 2.

The first and second coloring agents are coloring agents described in this specification, and liquid materials with a coloring material (industrial organic material) being solved and dispersed in water or other solvents. The organic material includes a dye or pigment (most thereof is the organic material and synthetic material). As the case may be, the dye is employed as the pigment whereas the pigment is employed as the dye. As a more concrete example, the coloring agent is a coloring liquid or paint.

The coloring liquid is a solvent in which dye is solved or dispersed. The paint is a liquid in which pigment is dispersed. Therefore, when the coloring agent is applied to the outer surface 5a of the first and second electric wires 1 and 2, the dye soaks into the coating 5, and when the paint is applied to the outer surface of the electric wires 1 and 2, the pigment adheres to the outer surface 5a without soaking into the coating 5.

Specifically, the first and second coloring units 31 and 32 dye portions of the outer surface 5a of the first and second electric wires 1 and 2 with the dye, or otherwise paint the outer surface 5a of the electric wires 1 and 2 with the pigment. Therefore, marking the outer surface 5a of the first and second electric wires is to dye portions of the outer surface 5a of the first and second electric wires with the dye, or to paint portions of the outer surface 5a of the first and second electric wires with the pigment.

The above solvent and dispersion liquid are desired to have affinity for the synthetic resin constituting the coating. In this case, the dye surely soaks into the coating 5 or the pigment surely adheres to the outer surface 5a of the coating 5. The “drop jetting” means that the coloring agents are jetted toward the outer surface of the electric wires by each drop (a certain quantity) in a liquid drop state. Therefore, the coloring agents are jetted by each drop in the liquid drop state toward the outer surface 5a of the outer surface 5 of each electric wire 1, 2 from the nozzles 35 and 39 of the coloring units 31 and 32 of the marking apparatus 21.

The encoder 33, as seen from FIG. 5, is provided with a rotor 42. The rotor 42 is rotatable around a shaft. The outer periphery of the rotor 42 is in contact with the outer surface 5a of the first and second electric wires 1 and 2 sandwiched between the pair of belt shifting units 13. The rotor 41 rotates when the core 4 and hence the first and second electric wires 1 and 2 travel in the direction of arrow K. Specifically, the rotor 42 rotates around the shaft as the core 4 and hence the first and second electric wires 1 and 2 travel in the direction of arrow K. It is of course that the traveling distance of the core 4 and hence the electric wires 1 and 2 in the direction of arrow K is proportional to the number of revolutions of the rotor 42.

The encoder 33 is connected to the control device 34. When a rotor 42 rotates by a prescribed angle, the encoder 33 produces a pulse signal to the control device 34. Namely, the encoder 33 supplies, to the control device 34, the information corresponding to the traveling speed of the core 4 and the first and second electric wires 1 and 2 in the direction of arrow K. In this way, the encoder 33 measures the information corresponding to the traveling speed of the core 4 and the first and second electric wires 1 and 2 in the direction of arrow K, and supplies the information to the control device 34. Generally, the encoder 33 produces the pulse signal corresponding to the traveling distance of the electric wires 1 and 2 by the friction between the electric wires 1, 2 and the rotor 42 attached to the encoder. However, where the traveling distance does not accord with the number of pulses according to the state of the outer surface 5a of the electric wires 1 and 2, speed information acquired at another site may be fed back for comparison/computation.

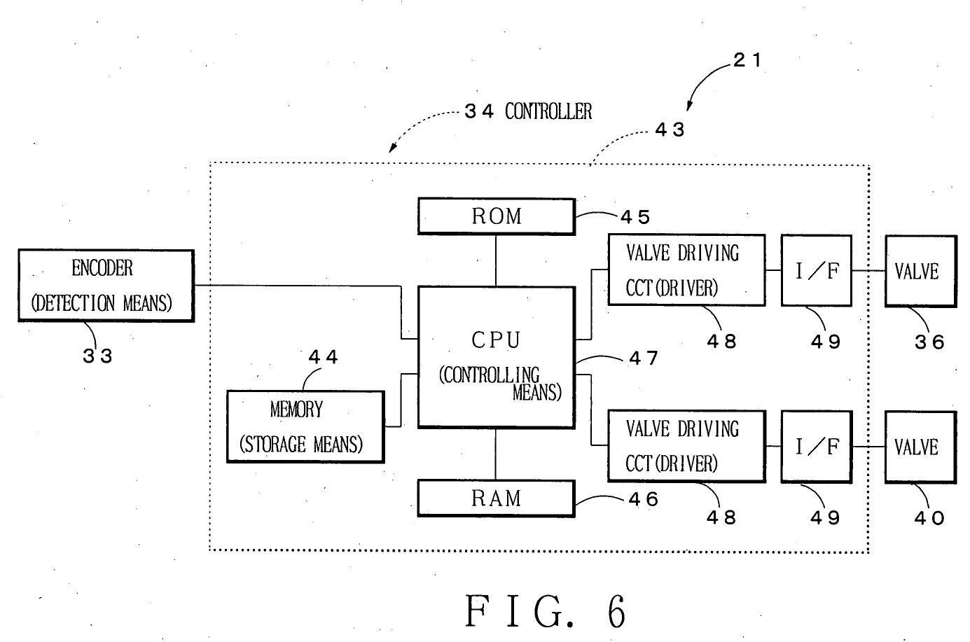

The control device 34 includes a box-shaped device body 43 (shown in FIG. 4), a memory 44 serving as a storage means, a well-known ROM (Read-Only Memory) 45, an RAM (Random Access Memory) 46, a CPU (Central Processing Unit) 47, a plurality of valve driving circuits 48, and a plurality of interfaces (I/F in FIG. 6) 49. The control device 34 may be a computer.

The control device 34 is connected to the encoder 33 and the valves 36 and 40 of the coloring units 31 and 32, thereby controlling the entire marking device 21. The device body 43 incorporates the memory 44, ROM 45, RAM 46, CPU 47, etc. The memory 44 stores patterns of the first and second markings 6 and 7 formed on the outer surface of the first electric wire 1 and patterns of the first and second markings 6 and 7 formed on the outer surface of the second electric wire 2. Concretely, the memory 44 stores the lengths D1, D3, interval D2, lengths d1, d3 and interval d2.

Further, the memory 44 stores the interval L between the nozzle 35 of the first coloring unit 31 and the nozzle 39 of the second coloring unit 32. The interval L is also the interval between the coloring units 31 and 32. The memory 44 is a well known non-volatile memory such as EEPROM. ROM 45 stores the operation program of CPU 47. RAM 46 temporarily stores the data necessary for computation in CPU 47.

CPU 47 serves as a control means. The CPU 47 receives the information on the traveling speed of the electric wire 1. The CPU 47 also receives the lengths D1, D3, interval D2, lengths d1, d3, interval d2 and interval L. The CPU 47 opens/closes the valves 36 and 40 so that the first markings 6 and second markings 7 are formed with the lengths D1, D3, interval D2, lengths d1, d3 and interval d2 according to the traveling speed of the first and second electric wires 1 and 2 supplied from the encoder 33. The CPU 47 controls the coloring units 31 and 32 to drop-jet the coloring agents toward the outer surface 5a of the first and second electric wires 1 and 2, thereby making the first markings 6 and second markings 7.

The valve driving circuits 48 and I/Fs 49 correspond to the coloring units 31 and 32, respectively and provided as the same number of units. The valve driving circuits 48 are connected to the valves 36 and 40 of the corresponding coloring units 31 and 32 through the I/Fs 49. In response to the signals for opening the corresponding valves 36 and 40 from the control device 34, the valve driving circuit 48 supplies the signals to the valves 36 and 40 through the I/Fs 49. Then, the corresponding valves 36 and 40 open.

In this way, the valve driving circuits 48 control the opening/closing of the corresponding valves 36 and 40 in such a manner that they supply the above signals to the corresponding valves 36 and 40. The I/Fs 49 are used to connect electrically the valve driving circuits 48 to the corresponding valves 36 and 40. The I/Fs 49 are attached to the outer wall of the device body 43.

Where the marking device 21 having the arrangement described above makes the first and second markings 6 and 7 on the outer surface 5a of the first and second electric wires 1 and 2, the pair of belt shifting units 13 of the electric wire cutting device 20 shift the first and second electric wires 1 and 2 in the direction of arrow K.

The control device 34 opens/closes the valves 36 and 40 according to the traveling speed of the first and second electric wires 1 and 2 and the interval L and others. According to the opening/closing of the valves 36 and 40, the first and second coloring agents are drop-jetted by a prescribed quantity from the nozzles 35 and 39 toward the outer surface 5a of the first and second electric wires 1 and 2. Thus, the first and second coloring agents are applied to the outer surface 5a of the first and second electric wires 1 and 2 to make the first and second markings 6 and 7 described above.

The belt shifting units 13 of the electric wire cutting device 20, after having shifted out the first and second electric wires 1 and 2 by the prescribed lengths, stop. Then, the cutting blades 17 and 18 of the cutting mechanism 12 cut the first and second electric wires 1 and 2 with the first and second markings 6 and 7 on their outer surface 5a. Thus, the first and second electric wires 1 and 2 with the first and second markings 6 and 7 on their outer surface 5a as shown in FIGS. 1 and 2 can be obtained.

In accordance with this embodiment, the first markings 6 and second markings 7 are arranged in the longitudinal direction of the first and second electric wires 1 and 2. Thus, the widths H1 and H2 (shown in FIG. 1) of the first marking 6 and second marking 7 in the circumferential direction of the first electric wire 1 and the widths h1 and h2 (shown in FIG. 2) of the first marking 6 and second marking 7 in the circumferential direction of the second electric wire 2 can be increased. For this reason, even when the first and second electric wires are thinned, the first markings 6 and second markings 7 can be easily visually recognized. The first marking 6 and second marking 7 are apart from each other, and the outer surface of the first and second electric wires 1 and 2 is white. This makes it easy to distinguish the markings 6 and 7 from each other and hence the electric wires 1 and 2 from each other. Thus, in assembling the wire harness 3, it is possible to prevent the electric wires 1 and 2 from being erroneously arranged and the quality of the wire harness from being reduced.

The lengths d1 and d3 of the first marking 6 and second marking 7 and the interval d2 therebetween of the second electric wires 2 are shorter than the lengths D1 and D3 of the first marking 6 and second marking 7 and the interval D2 therebetween of the first electric wire 1. The lengths d1 and d3 and the interval d2 are enough to cause both first and second markings 6 and 7 to be exposed outside the tube 9 for a harness. Therefore, both first and second markings are exposed at the end of the second electric wire 2 so that the first marking 6 and second marking 7 of the electric wire 2 accommodated in the tube for a harness can be easily visually recognized, thereby making it easy to distinguish these markings 6 and 7 from each other. As a result, the terminal fitting 8a attached to the end of the second electric wire 2 can be surely inserted in a desired terminal chamber 8c of the connector housing 8b.

The marking device 21 is attached to the electric wire cutting apparatus 20. Therefore, when the first and second lengthy electric wires 1 and 2 are cut in prescribed lengths, the prescribed markings can be applied to the first and second electric wires 1 and 2. This permits the number of man-hours required to process the first and second electric wires to be restricted.

In the embodiment described above, the wire harness 3 is equipped with the tube for a harness as an exterior component. However, in this invention, the exterior component may include a protector for a harness, grommet for a harness, a clip for wiring, etc. In this way, in this invention, the wire harness 3 is attached to the first and second electric wires 1 and 2 as an exterior component, and various components each covering (accommodating) at least a part of these electric wires.

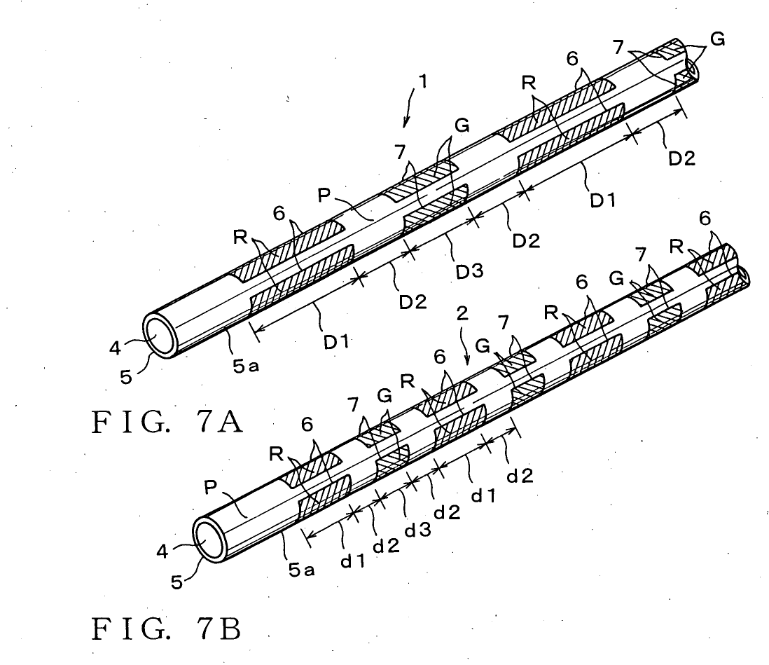

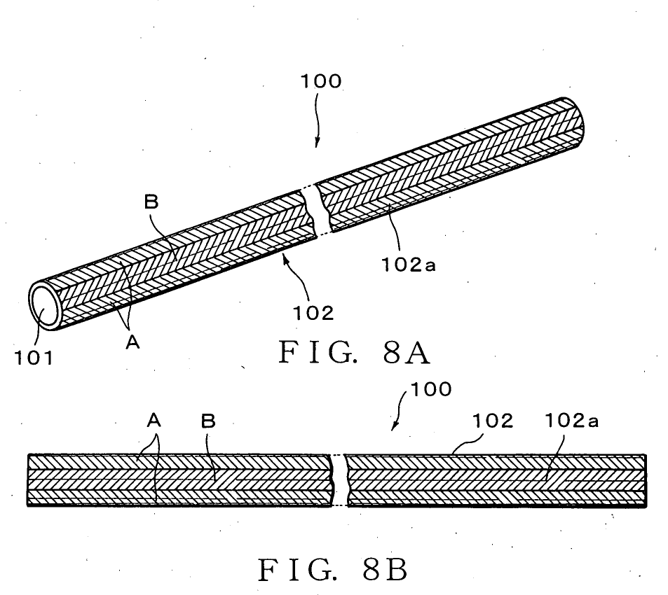

In the embodiments described above, the color of the outer surface 5a of the first and second electric wires 1 and 2 is white. However, in this invention, the synthetic resin constituting the coating 5 may not be colored, and the outer surface 5a of the coating 5 may be non-colored. The color P of the outer surface 5a of the coating 5 may be relatively bright right with brightness of 8 or more defined by JIS (Japanese Industrial Standards) relative to various hues. Further, as seen from FIGS. 7A and 7B, a plurality of the first and second markings 6 and 7 may be circumferentially arranged on the outer surface 5a of the first and second electric wires 1 and 2.

In the embodiment described above, the marking device 21 includes two coloring units (coloring units 31 and 32). However, in this invention, it is of course that three or more coloring units may be provided.

In the embodiment described above, the first and second coloring agents may be drop-jetted, by the prescribed quantity, toward the outer surface 5a of the first and second electric wires 1 and 2 to make the first and second markings 6 and 7. In this invention, however, portions of the outer surface 5a of the outer surface 5a of the first and second electric wires 1 and 2 may be immersed in (or impregnated with) the first and second coloring agents to make the first and second markings 6 and 7. Further, the coloring agent as well as pressurized vapor is sprayed, as aerosol, to portions of the first and second electric wires 1 and 2 to make the first and second markings 6 and 7.

Further, in the embodiment described above, the marking device 21 for making the first and second markings 6 and 7 is attached to the electric wire cutting apparatus 20. However, in this invention, it is of course that the marking device 21 may be attached to the device employed in various steps for processing the first and second electric wires in the manufacturing process of the wire harness 3.

In the embodiment described above, the control device is a computer which including a ROM 45, RAM 46, CPU 47, etc. However, the control device 34 may be a known digital circuit. In this case, the digital circuit may preferably include a circuit for counting the number of pulsating signals from the encoder 33, a circuit for deciding whether or not the valves 36 and 40 open/close when what number of pulsating signal is received, etc.

Further, in the embodiment described above, the description was given of the wire harness 3 arranged in a motor vehicle and the first and second electric wires 1 and 2 which constitute the wire harness 3. In this invention, however, it is of course that the wire harness 3 and first and second electric wires 1 and 2 may be employed for not only the motor vehicle but also various electronic devices such as a portable computer or various electric machines.

In this invention, various coloring liquids and paints such as acryl paint, ink (dye or pigment), UV ink, etc. may be employed.

### INDUSTRIAL APPLICABILITY

As understood from the description hitherto made, in the invention described in claim 1, since the first markings and second markings are arranged in the longitudinal direction of electric wires. Thus, the widths of the first marking and second marking in the circumferential direction of the electric wires can be increased. For this reason, even when these electric wires are thinned, the first markings and second markings can be easily visually recognized. Therefore, in assembling the wire harness, it is possible to prevent the electric wires from being erroneously arranged and the quality of the wire harness from being reduced.

In the invention described in claim 2, since the first marking and second marking are apart from each other. This makes it easy to distinguish the first marking and the second marking from each other and from the outer surface, and hence the electric wires from each other. Thus, in assembling the wire harness, it is possible to prevent the electric wires from being erroneously arranged and the quality of the wire harness from being reduced.

In the invention described in claim 3, since the outer surface of the coating is white, both of the first marking and the second marking can be easily distinguished from the outer surface, and hence the electric wires from each other. Thus, in assembling the wire harness, it is possible to prevent the electric wires from being erroneously arranged and the quality of the wire harness from being reduced.

In the invention described in claim 4, each of the first electric wire and the second electric wire which constitute the wire harness has the first markings and second markings on the outer surface of their coatings. The first markings and the second markings are arranged in the longitudinal direction of the coating, i.e. the electric wire. Thus, the widths of the first marking and second marking in the circumferential direction of the electric wires can be increased.

For this reason, even when these electric wires are thinned, the first markings and second markings can be easily visually recognized. Therefore, in assembling the wire harness, it is possible to prevent the electric wires from being erroneously arranged and the quality of the wire harness from being reduced.

The lengths of the first and second markings and the interval therebetween in the second electric wire are shorter than those in the first electric wire. Both first and second markings are exposed at the end of the second electric wire so that the first marking and second marking of the second electric wire accommodated in the tube for a harness can be easily visually recognized, thereby making it easy to distinguish these markings of the second electric wire from each other.

1. An electric wire including a conductive core and a coating which is made of synthetic resin and coats the core, comprising:
a first marking formed by coloring a portion of an outer surface of said coating with a first color which is different from that of said outer surface; and
a second marking formed by coloring another portion of the outer surface of said coating with a second color which is different from both the of said outer surface and said first color, wherein
said first marking and said second marking are arranged in a longitudinal direction of said coating.

2. An electric wire according to claim 1, wherein said first marking and said second marking are apart from each other.

3. An electric wire according to claim 1 or 2, wherein the outer surface of said coating is white.

4. A wire harness having a first electric wire connected to a connector at its end, and a second electric wire connected to another connector at its end and accommodated in an exterior component in the middle in the longitudinal direction thereof, wherein said first electric wire and said second electric wire each including a conductive core a coating which is made of synthetic resin and coats the core, a first marking formed by coloring a portion of an outer surface of said coating with a first color which is different from that of said outer surface; and a second marking formed by coloring another portion of the outer surface of said coating with a second color which is different from both the of said outer surface and said first color, wherein
said first marking and said second marking are arranged in a longitudinal direction of said coating,
the length of each of said first marking and said second marking of said second electric wire in the longitudinal direction is shorter than that of each of those of said first electric wire in the longitudinal direction, and
the interval between said first marking and said second marking of said second electric wire is shorter than that of said first electric wire, and the first marking and second marking of said second electric wire are exposed from said exterior component at the end of said second electric wire.
